(19) United States
(12) Patent Application Publication
(10) Pub. No.: US 2014/0016065 A1
(43) Pub. Date: Jan. 16, 2014

(54) LIQUID CRYSTAL DISPLAY WITH SAPPHIRE SUBSTATE

(71) Applicant: HON HAI PRECISION INDUSTRY CO., LTD., New Taipei (TW)

(72) Inventor: GA-LANE CHEN, Santa Clara, CA (US)

(73) Assignee: HON HAI PRECISION INDUSTRY CO., LTD., New Taipei (TW)

(21) Appl. No.: 13/721,054

(22) Filed: Dec. 20, 2012

(30) Foreign Application Priority Data
Jul. 13, 2012 (TW) 101125209

(51) Int. Cl. G02F 1/1333; G02F 1/1335

(52) U.S. Cl. CPC G02F 1/1333; G02F 1/133514; G02F 1/13338
USPC 349/96

(57) ABSTRACT

A liquid crystal displays includes a common electrode layer, a pixel electrode layer, a liquid crystal layer, an upper polarizer, a lower polarizer, a color filter, and a protection glass. The liquid crystal layer is positioned between the common electrode layer and the pixel electrode layer. The upper polarizer is positioned above the common electrode layer. The lower polarizer is positioned under the pixel electrode layer. The color filter is positioned between the upper polarizer and the common electrode layer. The protection glass is positioned above the common electrode layer and made of sapphire.

### BACKGROUND

1. Technical Field

The present disclosure relates to liquid crystal displays (LCD), and particularly, to an LCD with sapphire substrate.

2. Description of Related Art

LCDs generally include a protection glass made of common glass. However, the hardness, strength, and weather resistance of the protection glass are often less than satisfactory. As such, LCDs generally cannot be used in harsh environment conditions.

Therefore, it is desirable to provide an LCD, which can overcome the limitations described.

### BRIEF DESCRIPTION OF THE DRAWINGS

FIG. 1 is a cross-sectional schematic view of an LCD in accordance with a first exemplary embodiment.

FIG. 2 is a cross-sectional schematic view of an LCD in accordance with a second exemplary embodiment.

### DETAILED DESCRIPTION

Embodiments of the disclosure will be described with reference to the drawings.

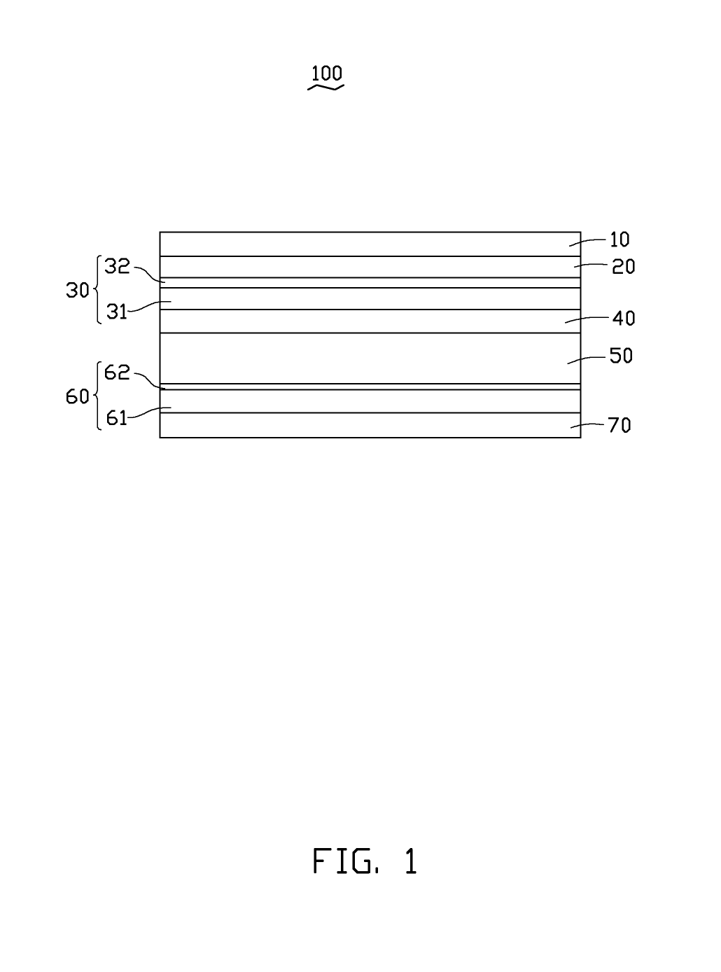

FIG. 1 shows an LCD 100, according to a first exemplary embodiment. The LCD 100 includes an upper polarizer 10, a protection glass 20, a color filter 30, a common electrode layer 40, a liquid crystal layer 50, a pixel electrode layer 60, and a lower polarizer 70.

The common electrode layer 40 and the pixel electrode layer 60 are positioned on two sides of the liquid crystal layer 50. The upper polarizer 10 is positioned above the common electrode layer 40. The lower polarizer 70 is positioned under the pixel electrode layer 60. The protection glass 20 and the color filter 30 are positioned between the upper polarizer 10 and the common electrode layer 40, with the protection glass 20 close to the upper polarizer 10 and the color filter 30 close to the common electrode layer 40.

It should be understood, in order to protect the LCD 100, the protection glass 20 can be positioned above the upper polarizer 10, and the color filter 30 is positioned between the upper polarizer 10 and the common electrode layer 40.

The polarities of the upper polarizer 10 and the lower polarizer 70 are opposite to each other. In this embodiment, the upper polarizer 10 transmits P-polarity lights and blocks lights of other polarities, and the lower polarizer 70 transmits S-polarity lights and blocks lights of other polarities.

The protection glass 20 is made of sapphire, and the hardness, strength, and weather resistance of the protection glass 20 is greater than the hardness, strength, and weather resistance of a mother glass. The safety and the reliability of the LCD 100 are ensured.

The color filter 30 includes a filter substrate 31 and a color resist layer 32 covered on the filter substrate 31. The filter substrate 31 is made of sapphire. The color filter 30 filters light by wavelength ranges, such that the separate filtered intensities include information about the color of light.

The common electrode layer 40 is an indium tin oxide film deposited on the filter substrate 31 by a chemical vapor deposition. In this embodiment, the color resist layer 32 and the common electrode layer 40 are covered on two opposite sides of the filter substrate 31.

Liquid crystal molecules of the liquid crystal layer 50 are arrayed in an initial alignment direction. The liquid crystal molecules are driven by an electric field generated between the common electrode layer 40 and the pixel electrode layer 60.

The pixel electrode layer 60 includes a pixel substrate 61 and a circuit layer 62 formed on the pixel substrate 61. The pixel substrate 61 is made of sapphire. The circuit layer 62 is made of a transparent material.

In the embodiment, the sapphire is a gemstone variety of the mineral corundum, and has a hexagonal crystal structure. The main chemical component of sapphire is aluminum oxide, and the refractive index of the sapphire is from about 1.757 to about 1.760. The growth direction of the sapphire is a-axis (11 2̅0), c-axis (0001), m-axis (10 1̅0). The hardness of the sapphire is from about 1500 Kg/mm2 to about 2000 Kg/mm2, the yield strength of the sapphire is from about 300 MPa to about 400 MPa, the compressive strength of the sapphire is about 2 GPa, the temperature range of the sapphire is from about −40 ° C. to about 2000° C.

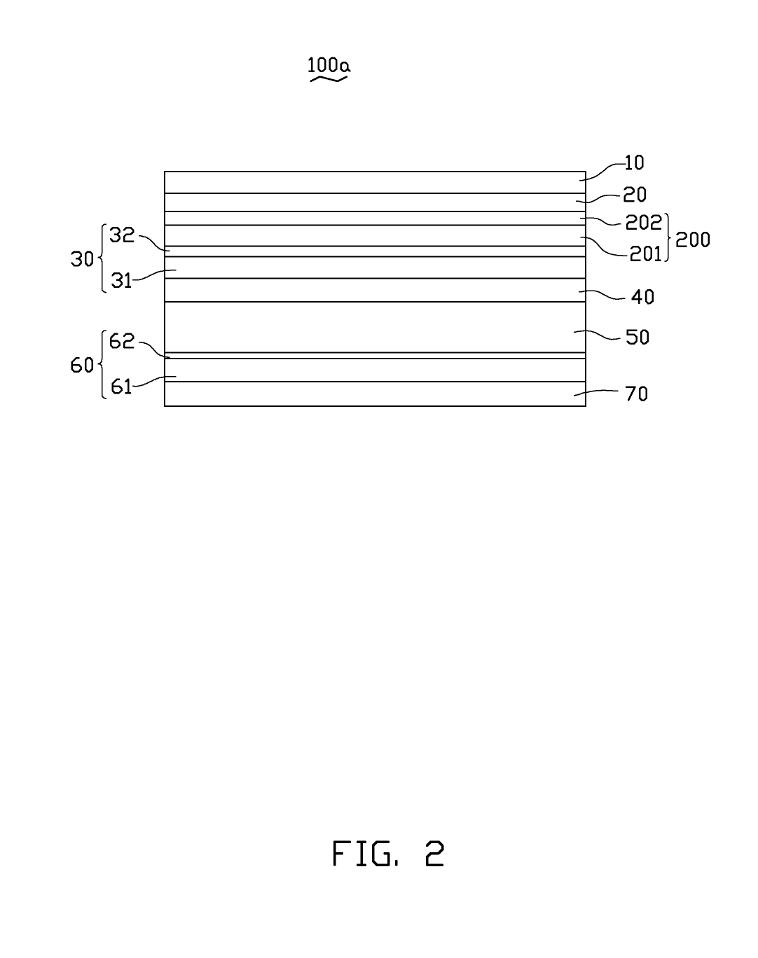

FIG. 2 shows an LCD 100a, according to a second exemplary embodiment. The difference between the LCD 100a and the LCD 100 of the first exemplary embodiment is that the LCD 100a further comprises a touch panel 200.

The touch panel 200 includes a touch substrate 201 and a touch layer 202 positioned on the touch substrate 201. The touch substrate 201 is made of sapphire. The touch layer 202 includes a number of X-axis sensors and a number of Y-axis sensors. The X-axis sensors and the Y-axis sensors are positioned on the touch substrate 201, and an arraying direction of the X-axis sensors is perpendicular to an arraying direction of the Y-axis sensors. The touch panel 200 acquires a touch position by an X-coordinate detected by the X-axis sensors and a Y-coordinate detected by the Y-axis sensors.

The touch panel 200 is positioned between the protection glass 20 and the color filter 30, with the touch layer 202 close to the protection glass 20 and the touch substrate 201 close to the color filter 30. As the touch substrate 201 of the touch panel 200 is made of sapphire, the damage of the touch panel 200 can be avoided in the process of touching.

In use, when the touch layer 202 covering the touch substrate 201 detects a touch operation on the upper polarizer 10, the touch panel 200 generates a touch signal to a controller. The controller controls the liquid crystal layer 50 displaying different images according to touch signals. As all of the filter substrate 31, the protection glass 20, the pixel substrate 61, and the touch substrate 201 are made of sapphire, the reliability of the LCD 100 and LCD 100a is increased.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A liquid crystal display (LCD), comprising:
a common electrode layer;
a pixel electrode layer;
a liquid crystal layer positioned between the common electrode layer and the pixel electrode layer;
an upper polarizer positioned above the common electrode layer;
a lower polarizer positioned under the pixel electrode layer;
a color filter positioned between the upper polarizer and the common electrode layer; and
a protection glass positioned above the common electrode layer and made of sapphire.

2. The LCD of claim 1, wherein the color filter comprises a filter substrate and a color resist layer covered on the filter substrate, and the filter substrate is made of sapphire.

3. The LCD of claim 1, wherein the pixel electrode layer comprises a pixel substrate and a circuit layer formed on the pixel substrate, and the pixel substrate is made of sapphire.

4. The LCD of claim 1, further comprising a touch panel positioned between the protection glass and the color filter.

5. The LCD of claim 4, wherein the touch panel comprises a touch substrate and a touch layer positioned on the touch substrate, and the touch substrate is made of sapphire.

6. The LCD of claim 1, wherein a refractive index of the sapphire is from about 1.757 to about 1.760, and a growth direction of the sapphire is a-axis (11 2̅0), c-axis (0001), m-axis (10 1̅0).

7. The LCD of claim 1, wherein polarities of the upper polarizer and the lower polarizer are opposite to each other.

8. The LCD of claim 1, wherein liquid crystal molecules of the liquid crystal layer are driven by an electric field generated between the common electrode layer and the pixel electrode layer.
